(19) United States
(12) Patent Application Publication
(10) Pub. No.: US 2012/0251872 A1
(43) Pub. Date: Oct. 4, 2012

(54) BATTERY PACK

(76) Inventor: Dukjung Kim, Yongin-si (KR)

(21) Appl. No.: 13/362,975

(22) Filed: Jan. 31, 2012

(30) Foreign Application Priority Data
Apr. 4, 2011 (KR) 10-2011-0030632

(51) Int. Cl. H01M 2/10

(52) U.S. Cl. 429/159

(57) ABSTRACT

A battery pack includes a plurality of secondary batteries, each of the secondary batteries including: an electrode assembly; a case accommodating the electrode assembly; and a collecting terminal electrically connected to the electrode assembly and protruding from the case; a first cover member on a first surface of each of the secondary batteries; and a first elastic member located between the first cover member and the first surface of each of the secondary batteries.

### CROSS-REFERENCE TO RELATED APPLICATION

This application claims priority to Korean Patent Application No. 10-2011-0030632 filed on Apr. 4, 2011, in the Korean Intellectual Property Office, the entire content of which is incorporated herein by reference.

### BACKGROUND

1. Field

Embodiments relate to a battery pack.

2. Description of the Related Art

Hybrid or electric vehicles, which use an interaction between an engine and a motor, may include a secondary battery as a power device. For example, lithium ion secondary batteries, which are non-aqueous secondary batteries having high output and high energy density, are often used as power sources of electric vehicles.

Such a secondary battery typically includes: a case; an electrode assembly including a positive electrode plate, a separator, and a negative electrode plate; a positive terminal connected to the positive electrode plate; a negative terminal connected to the negative electrode plate; and a cap plate coupled to the case to receive electrolyte and the electrode assembly and fixing the positive terminal and the negative terminal. The cap plate may include a safety vent that ruptures and emits gas when a large amount of gas is generated during the charging or discharging of the battery.

Such secondary batteries may be arranged in parallel, and may be connected to one another in parallel or in series to form a battery pack for generating high electric power.

### SUMMARY

An aspect of the present invention provides a battery pack, in which the top and bottom surfaces of secondary batteries are coupled to flat first and second cover members, thereby ensuring the flatness, durability and assembly quality of the secondary batteries.

Another aspect of the present invention provides a battery pack that includes elastic members between a cover member and the top surfaces of secondary batteries, and between the other cover member and the bottom surfaces of the secondary batteries, to absorb vibration, thereby improving the durability of the battery pack against external shock and vibration.

According to at least one of embodiments, a battery pack including: a plurality of secondary batteries including: an electrode assembly; a case accommodating the electrode assembly; and a collecting terminal electrically connected to the electrode assembly and protruding out of the case; a first cover member surrounding a first surface of the secondary batteries; and a first elastic member disposed between the first cover member and the first surface of the secondary batteries.

The first cover member may include: a first horizontal part having a plurality discharge holes; and a first sidewall part extending in a first direction extending from an edge of the first horizontal part to a second surface that is opposite to the first surface. The first horizontal part may include a positioning recess that is coupled to the first elastic member. The first elastic member may include a coil spring. The first horizontal part may include a first vertical part that protrudes in the first direction such that the first vertical part is fitted between the secondary batteries. The first vertical part may be disposed at a lower position than the first sidewall part. The secondary batteries may have at least one coupling recess in the first surface. The first elastic member may be fitted in the coupling recess.

The battery pack may further include a second cover member that has a through hole through which the collecting terminal passes, and that covers a second surface of the secondary batteries, and the second surface is opposite to the first surface. The battery pack may further include a second elastic member between the second cover member and the second surface of the secondary batteries. The second elastic member may include a leaf spring. Collecting terminals of neighboring ones of the secondary batteries may be electrically connected to each other through a bus bar. The bus bar may be disposed between the second surface of the secondary batteries and the second elastic member.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain principles of the present disclosure. In the drawings:

FIG. 1 is an exploded perspective view illustrating a battery pack according to an embodiment;

FIG. 2A is a front view illustrating a secondary battery of a battery pack according to an embodiment;

FIG. 2B is a side view illustrating the secondary battery of FIG. 2A;

FIG. 2C is a plan view of the secondary battery of FIG. 2A.

FIG. 3 is a perspective view illustrating a first cover member of a battery pack according to an embodiment;

FIG. 4 is a perspective view illustrating a second cover member of a battery pack according to an embodiment;

FIG. 5A is a perspective view illustrating a battery pack according to an embodiment;

FIG. 5B is a side view illustrating the battery pack of FIG. 5A;

FIGS. 6A through 6C are perspective views illustrating a process of assembling a battery pack as a secondary battery module according to an embodiment; and

FIG. 7 is an exploded perspective view illustrating a battery pack according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Hereinafter, embodiments will be described in detail with reference to the accompanying drawings.

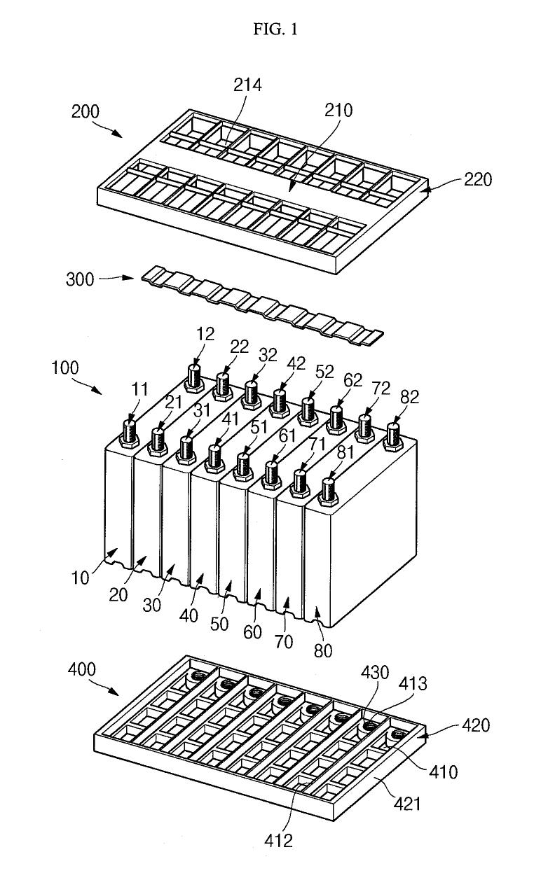

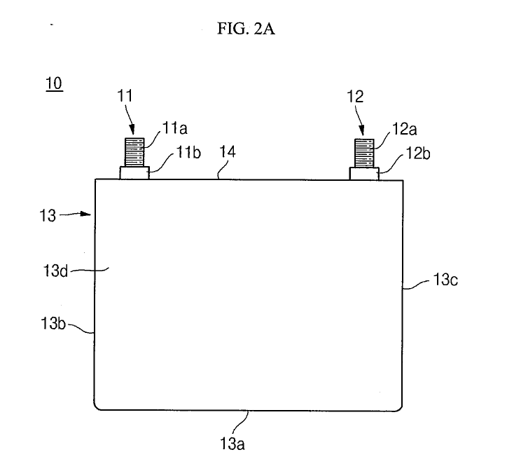

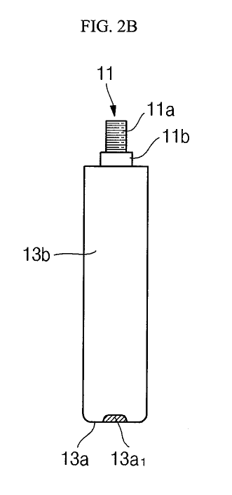

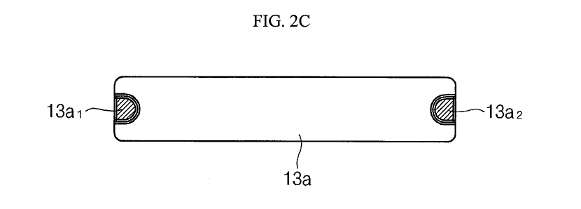

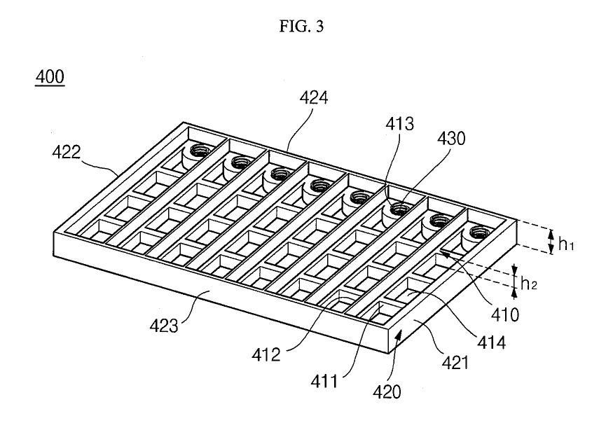

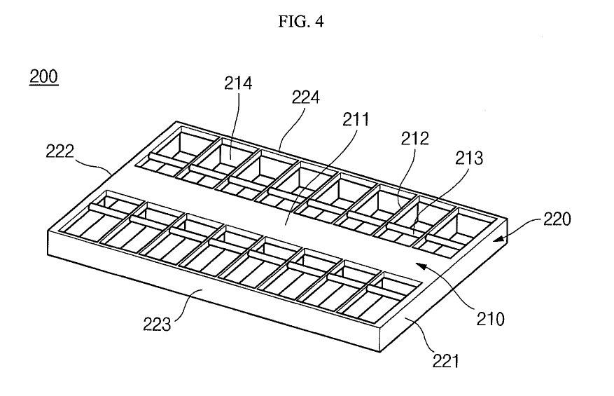

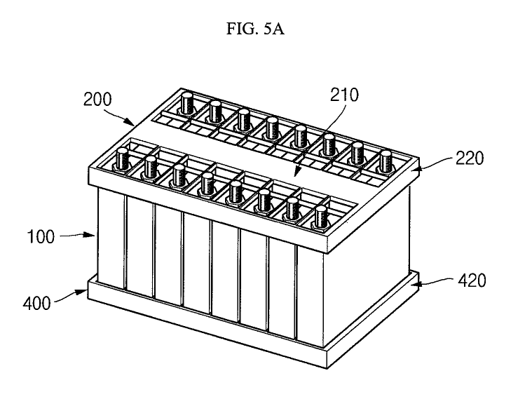

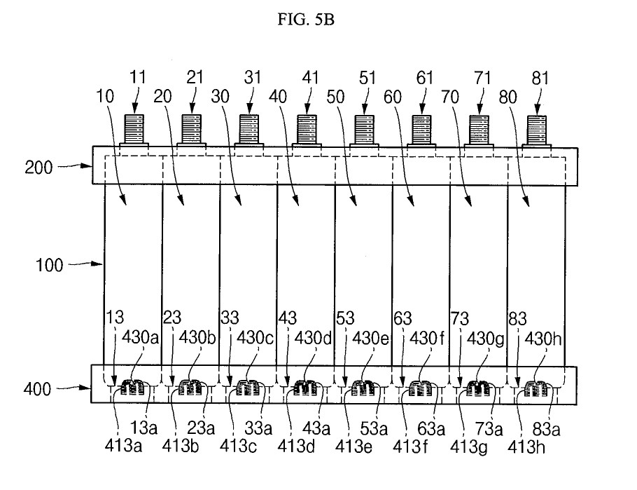

FIG. 1 is an exploded perspective view illustrating a battery pack according to an embodiment. FIG. 2A is a front view illustrating a secondary battery constituting a battery pack according to an embodiment. FIG. 2B is a side view illustrating a secondary battery constituting a battery pack according to an embodiment. FIG. 2C is a bottom view illustrating a secondary battery constituting a battery pack according to an embodiment. FIG. 3 is a perspective view illustrating a first cover member of a battery pack according to an embodiment. FIG. 4 is a perspective view illustrating a second cover member of a battery pack according to an embodiment. FIG. 5A is a perspective view illustrating a battery pack according to an embodiment. FIG. 5B is a side view illustrating a battery pack according to an embodiment.

Referring to FIGS. 1 and 5B, a battery pack according to an embodiment includes a secondary battery module 100, a first cover member 400, and a second cover member 200.

The secondary battery module 100 includes a plurality of secondary batteries 10, 20, 30, 40, 50, 60, 70, and 80, which are parallel and electrically connected to one another. There are eight secondary batteries 10, 20, 30, 40, 50, 60, 70, and 80 in the current embodiment, but the present invention is not limited thereto.

Referring to FIGS. 2A to 2C, the secondary battery 10 includes an electrode assembly, a case 13, a cap plate 14, and collecting terminals 11 and 12.

The electrode assembly may include a positive electrode plate, a separator, and a negative electrode plate. The positive electrode plate, the separator, and the negative electrode plate may be wound at a plurality of times in an approximately oval shape about a winding axis.

The case 13 has an approximately hexahedron shape provided with an opening through which the electrode assembly, a positive terminal (also denoted by 11), and a negative terminal (also denoted by 12) are inserted and placed. The case 13 may be formed of one of aluminum (Al), copper (Cu), iron (Fe), stainless steel (SUS), a ceramic, a polymer material, and an equivalent thereof, but the present invention is not limited thereto. The case 13 includes a first surface 13a that may include one or more coupling recesses 13a₁ and 13a₂. The coupling recesses 13a₁ and 13a₂ may be coupled to first elastic members 430 of the first cover member 400 to be described later.

The cap plate 14 is coupled to the case 13 to cover the electrode assembly. For example, the cap plate 14 may be coupled to the case 13 using laser welding, resistance welding, or supersonic welding. The cap plate 14 may be formed of the same material as the case 13. A safety vent may be located on the cap plate 14. When an inner pressure of the case 13 is equal to or greater than an allowance value, the safety vent ruptures to emit inner gas to the outside. The safety vent may be thinner than the cap plate 14.

The collecting terminals 11 and 12 include the positive terminal 11 and the negative terminal 12 which are coupled to and protrude from the cap plate 14. The positive terminal 11 and the negative terminal 12 are threaded to allow a bus bar to be coupled and fixed thereto. Terminal plates 11b and 12b are coupled to upper regions 11a and 12a of the positive terminal 11 and the negative terminal 12, respectively. The terminal plates 11b and 12b may be nuts having a hexagonal column shape. The positive terminal 11 may be electrically connected through a collecting plate to the positive electrode plate of the electrode assembly and the negative terminal 12 may be electrically connected through a collecting plate to the negative electrode plate of the electrode assembly. The positive terminal 11 and the negative terminal 12 may be formed of aluminum (Al) and copper (Cu), respectively, but the present invention is not limited thereto.

Referring to FIG. 3, the first cover member 400 covers first surfaces (that is, bottom surfaces) 13a, 23a, 33a, 43a, 53a, 63a, 73a, and 83a of the secondary batteries 10, 20, 30, 40, 50, 60, 70, and 80. The first elastic members 430 are located between the first cover member 400 and the respective first surfaces 13a, 23a, 33a, 43a, 53a, 63a, 73a, and 83a. The first elastic members 430 include coil springs 430a, 430b, 430c, 430d, 430e, 430f, 430g, and 430h (FIG. 5B) to correspond to the first surfaces 13a, 23a, 33a, 43a, 53a, 63a, 73a, and 83a. The first elastic member 430 may be a coil spring, but the present invention is not limited thereto.

The first cover member 400 includes a first horizontal part 410 and a first sidewall part 420. The bottom surface of the first horizontal part 410 is substantially flat and may include a plurality of discharge holes 414 to discharge and introduce gas or water. The discharge holes 414 are surrounded by a plurality of sidewalls 411. The first sidewall part 420 extends in a first direction from edges of the first horizontal part 410 to second surfaces that are opposite to the first surfaces 13a, 23a, 33a, 43a, 53a, 63a, 73a, and 83a, that is, extends upward, and is perpendicular to the first horizontal part 410. The first sidewall part 420 includes sidewalls 421, 422, 423, and 424, which are perpendicular to the first horizontal part 410. The first horizontal part 410 may further include first vertical parts 412 that protrude in the first direction, so that the first vertical parts 412 can be fitted between the secondary batteries 10, 20, 30, 40, 50, 60, 70, and 80. The first vertical parts 412 may be located at a lower position than the first sidewall part 420, i.e., they may be recessed from the first sidewall part. The first vertical parts 412 contact the first surfaces 13a, 23a, 33a, 43a, 53a, 63a, 73a, and 83a of the secondary batteries 10, 20, 30, 40, 50, 60, 70, and 80, and the first sidewall part 420 surrounds the first surfaces 13a, 23a, 33a, 43a, 53a, 63a, 73a, and 83a, and side surfaces adjacent thereto. Accordingly, the first cover member 400 is coupled to the lower portions of the secondary batteries 10, 20, 30, 40, 50, 60, 70, and 80.

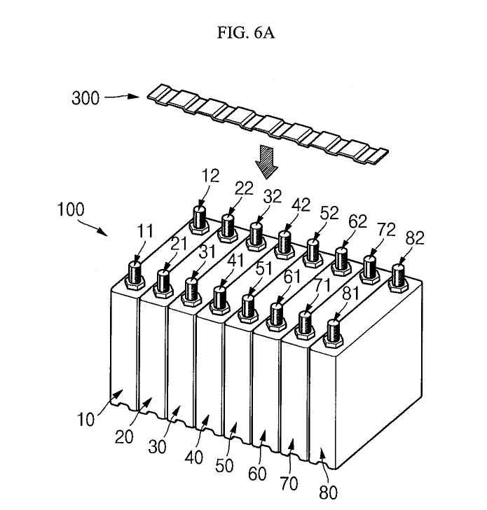

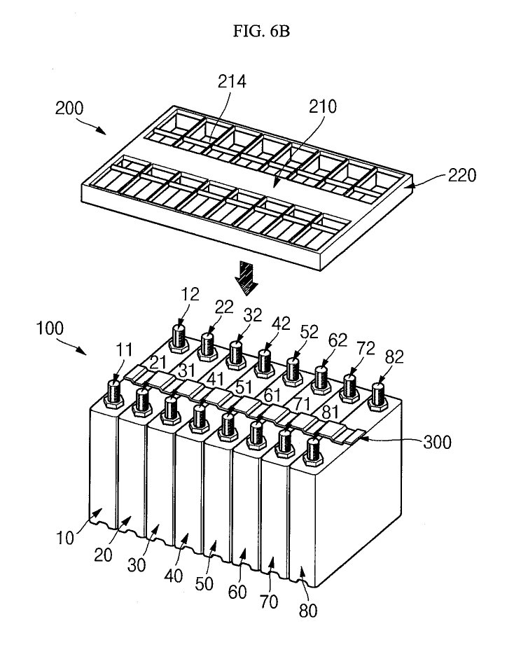

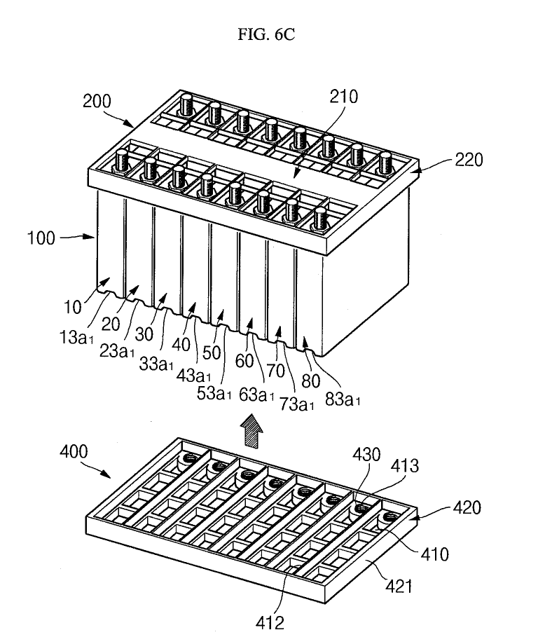

The first horizontal part 410 includes positioning recesses 413 coupled to the coil springs (also denoted by 430). The positioning recesses 413 include the positioning recesses 413a, 413b, 413c, 413d, 413e, 413f, 413g, and 413h to correspond to a plurality of coil springs 430a, 430b, 430c, 430d, 430e, 430f, 430g, and 430h. The positioning recesses 413 may be located on both side portions of the top surface of the first horizontal part 410, but the present invention is not limited thereto. The lower portion of the coil spring 430 is coupled to the inner portion of the positioning recess 413, and the upper portion thereof protrudes out of the positioning recess 413. The upper portions of the coil springs 430 contact coupling recesses (refer to FIG. 6C) of the first surfaces 13a, 23a, 33a, 43a, 53a, 63a, 73a, and 83a to absorb shock or vibration applied from the outside of the secondary batteries 10, 20, 30, 40, 50, 60, 70, and 80, thereby improving the durability of the secondary batteries 10, 20, 30, 40, 50, 60, 70, and 80.

Referring to FIG. 4, the second cover member 200 includes through holes 214 through which collecting terminals 11, 21, 31, 41, 51, 61, 71, 81, 12, 22, 32, 42, 52, 62, 72, and 82 of the secondary batteries 10, 20, 30, 40, 50, 60, 70, and 80 constituting the secondary battery module 100 pass, and surrounds the second surfaces that are opposite to the first surfaces 13a, 23a, 33a, 43a, 53a, 63a, 73a, and 83a, that is, surrounds the top surfaces of the secondary batteries 10, 20, 30, 40, 50, 60, 70, and 80. The through holes 214 may have a circular shape and a polygonal shape such as a tetragonal shape, from a plan view, but the present invention is not limited thereto. The second cover member 200 may be formed of one of aluminum (Al), copper (Cu), iron (Fe), stainless steel (SUS), a ceramic, a polymer material, and an equivalent thereof, but the present invention is not limited thereto.

The second cover member 200 includes a second horizontal part 210 and a second sidewall part 220, wherein the through holes 214 are located in the second horizontal part 210. A top surface 211 of the second horizontal part 210 is flat and the second sidewall part 220 extends in a second direction extending from edges of the second horizontal part 210 to the first surfaces 13a, 23a, 33a, 43a, 53a, 63a, 73a, and 83a, that is, extends downward, and includes sidewalls 221, 222, 223, and 224, which are substantially perpendicular to the second horizontal part 210. The second horizontal part 210 may further include second vertical parts 212 that protrude in the second direction, so that the second vertical parts 212 can be fitted between neighboring secondary batteries 10, 20, 30, 40, 50, 60, 70, and 80. The second vertical parts 212 may be located at a higher position than the second sidewall part 220. Thus, the second vertical parts 212 contact the second surfaces of the secondary batteries 10, 20, 30, 40, 50, 60, 70, and 80, and the second sidewall part 220 surrounds the second surfaces and side surfaces adjacent to the second surfaces, so that the second cover member 200 is fixed to the upper portion of the secondary batteries 10, 20, 30, 40, 50, 60, 70, and 80. The second horizontal part 210 may further include horizontal members 213 that are perpendicular to the second vertical parts 212 and pass through the second vertical parts 212 and the second sidewall part 220.

A second elastic member 300 may be located between the second cover member 200 and the second surfaces of the secondary batteries 10, 20, 30, 40, 50, 60, 70, and 80. The second elastic member 300 may be a leaf spring, but the present invention is not limited thereto. The second elastic member 300 (hereinafter, referred to as a leaf spring) extends in an array direction of the secondary batteries 10, 20, 30, 40, 50, 60, 70, and 80, and absorbs shock and vibration applied from the outside of the second cover member 200 to protect the secondary batteries 10, 20, 30, 40, 50, 60, 70, and 80, thereby improving the durability thereof. The leaf spring 300 may be formed of a copper alloy having high elasticity, such as one of phosphorus bronze, beryllium copper, and brass, but the present invention is not limited thereto.

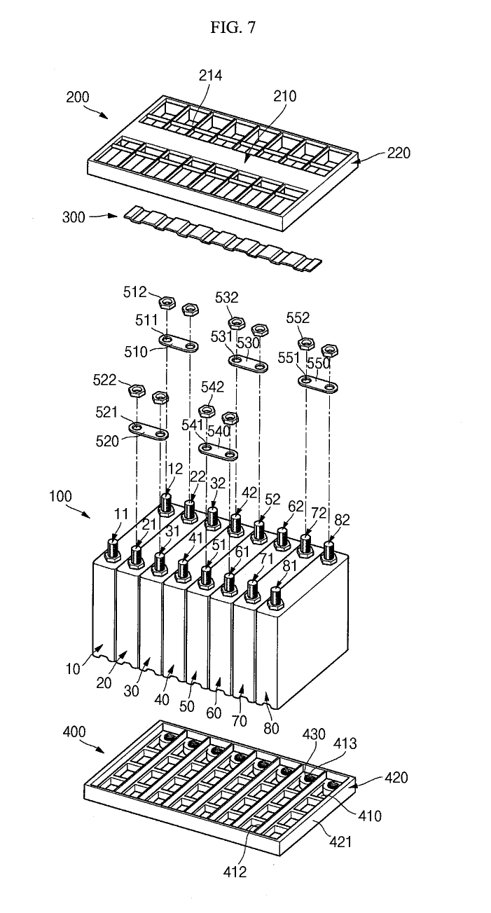

The collecting terminals of neighboring ones of the secondary batteries 10, 20, 30, 40, 50, 60, 70, and 80 may be connected to each another through bus bars. For example, one of the bus bars, denoted by 510 in FIG. 7, may electrically connect the collecting terminal 12 of the secondary battery 10 to the collecting terminal 22 of the secondary battery 20 adjacent thereto. The leaf spring 300 contacts the top surface of the bus bar 510 and the bottom surface of the second horizontal part 210 of the second cover member 200, which will be described later with reference to FIG. 7.

According to the embodiment, since the top and bottom surfaces of the batteries are coupled to the flat first and second cover members, the flatness, durability and assembly quality of the secondary batteries can be ensured, and further, swelling due to inner pressure increased during the charging and discharging of the secondary batteries is prevented more efficiently.

FIGS. 6A through 6C are perspective views illustrating a process of assembling a battery pack with a secondary battery module according to an embodiment.

Referring to FIG. 6A, the leaf spring 300 is coupled to the secondary battery module 100 in which the secondary batteries 10, 20, 30, 40, 50, 60, 70, and 80 are parallel and electrically connected to one another. That is, the leaf spring 300 extends in the array direction of the secondary batteries 10, 20, 30, 40, 50, 60, 70, and 80 is located between a group of the positive terminals 11, 21, 31, 41, 51, 61, 71, and 81, and a group of the negative terminals 12, 22, 32, 42, 52, 62, 72, and 82, which are located on the second surfaces (top surfaces) of the secondary batteries 10, 20, 30, 40, 50, 60, 70, and 80.

Referring to FIG. 6B, the cover member 200 is coupled to both the secondary battery module 100 and the leaf spring 300. That is, the second horizontal part 210 of the cover member 200 closely contacts the leaf spring 300, and the positive terminals 11, 21, 31, 41, 51, 61, 71, and 81, and the negative terminals 12, 22, 32, 42, 52, 62, 72, and 82 pass through the through holes 214, and the second sidewall part 220 surrounds the upper edges of the secondary battery module 100.

Referring to FIG. 6C, the first cover member 400 is coupled to the lower portion of the secondary battery module 100. At this point, the coil springs 430a, 430b, 430c, 430d, 430e, 430f, 430g, and 430h are located in the positioning recesses 413a, 413b, 413c, 413d, 413e, 413f, 413g, and 413h of the first cover member 400, and are coupled to coupling recesses 13a₁, 23a₁, 33a₁, 43a₁, 53a₁, 63a₁, 73a₁, and 83a₁ formed in the first surfaces 13a, 23a, 33a, 43a, 53a, 63a, 73a, and 83a.

FIG. 7 is an exploded perspective view illustrating a battery pack according to an embodiment.

Referring to FIG. 7, a battery pack according to an embodiment includes a secondary battery module 100, a first cover member 400, and a second cover member 200. Since the first and second cover members 400 and 200 of the battery pack of FIG. 7 are the same as the first and second cover members 400 and 200 of the battery pack of FIGS. 1 through 5B, the battery pack of FIG. 7 according to the current embodiment will now be described with respect to the secondary battery module 100.

The secondary battery module 100 is formed by placing the secondary batteries 10, 20, 30, 40, 50, 60, 70, and 80 parallel to one another, and electrically connecting the secondary batteries 10, 20, 30, 40, 50, 60, 70, and 80 to one another through bus bars 510, 520, 530, 540, and 550. The secondary batteries 10, 20, 30, 40, 50, 60, 70, and 80 may be connected to one another in series and/or in parallel through the bus bars 510, 520, 530, 540, and 550, which are electrically conductive. The bus bars 510, 520, 530, 540, and 550 include through holes 511, 521, 531, 541, and 551 at both sides thereof, respectively. The through holes 511, 521, 531, 541, and 551 are coupled to the positive terminals 11, 21, 31, 41, 51, 61, 71, and 81 and the negative terminals 12, 22, 32, 42, 52, 62, 72, and 82 of the secondary batteries 10, 20, 30, 40, 50, 60, 70, and 80. The second surfaces of the secondary batteries 10, 20, 30, 40, 50, 60, 70, and 80 are coupled to the leaf spring 300 extending in the array direction thereof. The positive terminals 11, 21, 31, 41, 51, 61, 71, and 81 and the negative terminals 12, 22, 32, 42, 52, 62, 72, and 82 couple to nuts 512, 522, 532, 542, and 552, after passing through the bus bars 512, 522, 532, 542, and 552. Although not shown, alternatively, the positive terminals 11, 21, 31, 41, 51, 61, 71, and 81 and the negative terminals 12, 22, 32, 42, 52, 62, 72, and 82 may be riveted to the bus bars 510, 520, 530, 540, and 550, after passing through the bus bars 510, 520, 530, 540, and 550. The top and bottom surfaces of the secondary battery module 100 configured as described above are coupled to the first and second cover members 200 and 400, respectively. The bus bars 510, 520, 530, 540, and 550 may be formed of one of stainless steel, aluminum, an aluminum alloy, copper, a copper alloy, and an equivalent thereof, but the present disclosure is not limited thereto.

Thus, according to one embodiment, the leaf spring is located between the top surfaces of the secondary batteries and the second cover member, and the coil spring is located between the bottom surface of each secondary battery and the first cover member, to absorb vibration, thereby improving the durability of the battery pack against external shock and vibration.

According to the embodiment, since the top and bottom surfaces of the batteries are coupled to the flat first and second cover members, the flatness, durability and assembly quality of the secondary batteries can be ensured, and further, swelling due to inner pressure increased during the charging and discharging of the secondary batteries is prevented more efficiently.

As will be appreciated, the secondary battery can be coupled to a motor for propelling an electric vehicle or a hybrid electric vehicle. In doing so, the vehicle will be able to operate on less or no traditional fuel like gasoline, and therefore, be more environmentally friendly.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present disclosure as set forth in the following claims.

1. A battery pack comprising:
a plurality of secondary batteries, each of the secondary batteries including: an electrode assembly; a case accommodating the electrode assembly; and a collecting terminal electrically connected to the electrode assembly and protruding from the case;
a first cover member on a first surface of each of the secondary batteries; and
a first elastic member located between the first cover member and the first surface of each of the secondary batteries.

2. The battery pack as claimed in claim 1, wherein the first elastic member comprises a coil spring.

3. The battery pack as claimed in claim 1, wherein the first cover member comprises:
a first horizontal part having a plurality discharge holes; and
a first sidewall part extending in a first direction from an edge of the first horizontal part.

4. The battery pack as claimed in claim 3, wherein the first horizontal part comprises a positioning recess that accommodates the first elastic member.

5. The battery pack as claimed in claim 3, wherein the first horizontal part comprises a first vertical part that protrudes in the first direction such that the first vertical part is located between adjacent ones of the secondary batteries.

6. The battery pack as claimed in claim 5, wherein the first vertical part is recessed from the first sidewall part.

7. The battery pack as claimed in claim 1, wherein each of the secondary batteries has at least one coupling recess in the first surface.

8. The battery pack as claimed in claim 7, wherein the first elastic member is in one of the at least one coupling recess.

9. The battery pack as claimed in claim 1, further comprising a second cover member that has a through hole through which the collecting terminal passes, and that covers a second surface of each of the secondary batteries, wherein the second surface is opposite to the first surface.

10. The battery pack as claimed in claim 9, further comprising a second elastic member between the second cover member and the second surface of each of the secondary batteries.

11. The battery pack as claimed in claim 10, wherein the second elastic member comprises a leaf spring.

12. The battery pack as claimed in claim 10, wherein collecting terminals of adjacent ones of the secondary batteries are electrically connected to each other through a bus bar.

13. The battery pack as claimed in claim 12, wherein the bus bar is located between the second surface of the secondary batteries and the second elastic member.
